(19) United States
(12) Patent Application Publication
(10) Pub. No.: US 2011/0118491 A1
(43) Pub. Date: May 19, 2011

(54) PROCESS FOR THE PRODUCTION OF NO-CARRIER ADDED 99 MO

(76) Inventors: Hubert Theodor Wolterbeek, Leidschendam-Voorburg (NL); Peter Bode, Zuid-Beijerland-Korendijk (NL)

(21) Appl. No.: 12/996,209

(22) PCT Filed: Jun. 2, 2009
(86) PCT No.: PCT/NL09/50301

§ 371 Date: Jan. 28, 2011

(30) Foreign Application Priority Data
Jun. 6, 2008 (EP) 08157758.7

(51) Int. Cl. C07F 11/00

(52) U.S. Cl. 556/59; 556/58

(57) ABSTRACT

The present invention relates to a process for the production of no-carrier added ⁹⁹Mo by neutron activation of ⁹⁸Mo thereby reaching specific radioactivity which allow the use of such produced ⁹⁹Mo as an option for the ⁹⁹Mo produced by the fission of ²³⁵U. This has been achieved by taking advantage of the recoil of the ⁹⁹Mo nuclei upon the capture of neutrons by the ⁹⁸Mo containing compound. These recoiled nuclei are no longer chemically bound to the ⁹⁸Mo containing compound allowing further specific separation. Preferred ⁹⁸Mo containing compounds are molybdenum(O)hexacarbonyl [(Mo(CO)₆] and molybdenum (VI) di oxodioxinate [C₄H₃(O) —NC₅H₃) J₂-MoO₂.

The present invention relates to a process for the production of no-carrier added ⁹⁹Mo.

According to the current practice, ⁹⁹Mo with high specific radioactivity is produced by fission of fissile actinide targets (²³³U, ²³⁵U, ²³⁹Pu etc), mostly using ²³⁵U, wherein ⁹⁹Mo is one of the fission products of high yield (ca. 6%). However, next to this ⁹⁹Mo a range of other further fission products are produced as well. The consequence of this production route is that the production requires handling of nuclear fuel, wherein ⁹⁹Mo has to be isolated and purified from the other fission products. Furthermore, the prior art process involves a final storage of the co-produced additional fission products. This total implicates that only few production sites of ⁹⁹Mo exist with the required production licenses. In turn, this makes that the world-production of ⁹⁹Mo-^{99m}Tc generators (used in medical radio-imaging) is based on only a very few sites, wherein any problem in one of the current sites immediately endangers the continuity of the necessary supply.

Now the present invention aims to provide a process for the production of ⁹⁹Mo of high specific radioactivity, wherein the above-mentioned disadvantages are removed.

The present invention enables the production of no-carrier added ⁹⁹Mo by neutron activation of ⁹⁸Mo, thereby achieving specific radioactivity which allows the use of such produced ⁹⁹Mo as a favorable option (alternative) for the ⁹⁹Mo production by means of the fission of ²³⁵U. This high specific radioactivity is obtained according to the invention by taking advantage of the recoil of the ⁹⁹Mo nuclei upon the capture of neutrons by the ⁹⁸Mo containing nuclei. The mentioned recoiled nuclei are no longer chemically bound to the target matrix and thus allow for specific separation.

Accordingly the present invention relates to a process for the production of no-carrier added ⁹⁹Mo of high specific radioactivity, characterized in that an ⁹⁸Mo containing chemical compound is bombarded with neutrons and the resulting ⁹⁹Mo radioactivity which is incorporated in said compound is separated.

It has been surprisingly found that by bombarding ⁹⁸Mo containing chemical compound with neutrons, ⁹⁹Mo with high specific radioactivity may be obtained without the disadvantages of the prior art fission of ²³⁵U. Obviously, next to ⁹⁹Mo no additional fission products are formed.

There are two options for the process for the present invention.

According to the first option, said ⁹⁹Mo radioactivity, incorporated in said compound, is a) transferred into a liquid in which only the produced ⁹⁹Mo dissolves, or b) transferred into a liquid in which said compound has a high solubility which liquid is mixed with a second liquid wherein said compound does not dissolve and the “loose” ⁹⁹Mo nuclei are transferred into said second liquid phase.

Thus, after bombarding the ⁹⁸Mo containing chemical compound with neutrons the produced ⁹⁹Mo radioactivity incorporated in said compound is transferred into a liquid in which only the produced ⁹⁹Mo dissolves or into a first liquid having a high solubility for said compound having ⁹⁹Mo radioactivity.

Said first liquid is mixed with a second liquid, wherein the “loose” ⁹⁹Mo nuclei are transferred by extraction into a second liquid phase, wherein the compound does not dissolve.

Preferred ⁹⁸Mo containing compounds are molybdenum(O)hexacarbonyl[(Mo(CO)₆] and molybdenum(VI)dioxodioxinate [C₄H₃(O)—NC₅H₃)]₂—MoO₂.

Next to these preferred molybdenum compounds the following molybdenum compounds may be used.

Cycloheptatrienemolybdenum(O)tricarbonyl [(C₇H₈)Mo (CO)₃], d. purple cryst. powder (Across Organics);

Molybdenum(O)hexacarbonyl [(Mo(CO)₆], white, crystalline powder (Across Organics);

Methylcyclopentadienylmolybdenum(I)tricarbonyl, dimer [(CH₃)₂—(C₅H₅)]₂—Mo₂(CO)₆ d. purple, crystalline powder (Across Organics);

Propylcyclopentadienylmolybdenum(I)tricarbonyl, dimer [CH₃CH₂CH₂)—(C₅H₅)]₂—Mo₂(CO)₆ d. brown, crystall. Powder (Across Organics);

Cyclopentadienylmolybdenum(II) tricarbonyl dimer [(C₅H₅)—Mo(CO)₃]₂, d. purple cryst. powder (Across Organics);

Pentamethylcyclopentadienyl-molybdenum(V) dicarbonyl dimer [(CH₃)₅—(C₅H₅)—Mo(CO)₂]₂ olive-green crystalline powder;

Molybdenum(VI)dioxo-Bis(acetylacetonato) [(CH₃COCH═C(O—)CH₃]₂—MoO₂, white, cristalline powder (Sigma Aldrich, USA).

Molybdenum(VI)dioxo-dioxinate [(C₄H₃(O)—NC₅H₃)]₂—MoO₂, orange-yellow cristalline powder, was synthesized according to the method as described in Vogel et. al. [xxx].

Molybdenum(IV)disulfide [MoS₂], d. grey powder, 325 Mesh (Across Organics);

Molybdenum disilicide [MoSi₂], d. grey powder, 325 Mesh (Alfa Aesar GmbH, Karlsruhe, Germany);

Molybdenum nanoparticles (˜100 nm), d. grey powder, (Johnson & Matthey, USA)

Potassium molybdenum(VI)-hexacyanoferrate [KMo[Fe^{III}(CN)₆], d. brown, crystalline powder was synthesized according to the method as described by Sebesta et. al. [yy]

Preferred first liquid is an organic solvent dichloromethane (CH₂Cl₂), whereas the second preferred liquid is an aqueous phase of different pH (2-12) prepared in 50 mM ammonium acetate buffer.

Other suitable first liquids are chloroform (CH₃Cl), benzene (C₆H₆) , toluene (CH₃—C₆H₅).

Other suitable second liquids are aqueous solutions of acidic solution HCl (0.05 M), alkaline solution NaOH (0.05 M), chelating solutions Na₂EDTA (0.05 M), Na₃citrate (0.05 M), oxidizing solution H₂O₂ (0.02 M) in HCl (0.05 M), reducing solution (NaHSO₃ (0.05 M), saline solution NaCl (0.9% w/w), neutral buffer solution NH₄Ac (0.05 M; pH 7.3).

According to a second optional variant of claim 1, a ⁹⁸Mo containing compound is transferred into an irradiation container containing 1) a liquid in which only the produced ⁹⁹Mo dissolves, or 2) a liquid in which the compound dissolves, as well as the liquid (non-mixable with the first liquid) in which the ⁹⁹Mo dissolves and the compound does not dissolve, the container is, under continuous shaking, irradiated with neutrons in an external neutron beam, resulting in transfer of the recoiled ⁹⁹Mo on-line from one to another liquid phase.

Also by using of this variant, the disadvantages of the prior art fission process are removed.

It is noted that the present process is new and not obvious over the current techniques, because the current techniques did not significantly increase the molybdenum specific radioactivity due to non-suited Mo-compounds and/or non-suited extraction protocols. The prior art technique predominantly by fission of nuclear fuel (²³⁵U) was until now used worldwide for large-scaled production of no-carrier added ⁹⁹Mo with the disadvantages as mentioned herein before.

It is noted that the recoil-production of ⁹⁹Mo leads to ⁹⁹Mo with the required high specific radioactivity without the otherwise obligatory processing of nuclear fuel accompanied by the disadvantages as mentioned before.

Furthermore, it is noted that currently there are no production options other than by the fission-produced ⁹⁹Mo which lead to comparable specific radioactivity. Because for the fission-produced ⁹⁹Mo, production facilities should process nuclear fuel and only a small number of facilities worldwide have the required licenses as mentioned before. The proposed production by recoil-⁹⁹Mo from neutron irradiation of enriched ⁹⁸Mo targets implies that many more facilities worldwide could start up the production of high radioactivity ⁹⁹Mo.

Although the principle of the recoil (Szilard-Chalmers) reactions is known, it is surprising that by using the right chemical compounds and experimental conditions, such as the availability of a neutron beam of adequate density ⁹⁹Mo of high specific radioactivity may be obtained by the invention. Therefore, the present process is not only new, but also inventive over the current ⁹⁹Mo producing technique.

Further, there are no disadvantages of the present process apart from the necessary entrance to a neutron source coupled to a radiochemical infrastructure.

Further to the process options according to claims 2 and 6, it is remarked that according to claim 2 the bombardment of the ⁹⁸Mo chemical compound with neutrons occurs in the reactor, whereas according to option disclosing claim 6 the bombardment occurs outside the reactor in a neutron beam.

It is noted that the present process is not limited to the production of ⁹⁹Mo but it may be used for other products which at the moment are mainly produced through the ²³⁵U fission process.

The process of the invention is also suitable for the production of ⁹⁰Sr->⁹⁰Y; ¹⁰³Ru->^{103m}Ru; ¹³²Te->¹³²I; ¹³⁷Cs->^{137m}Ba and ¹⁴⁰Ba->¹⁴⁰La.

The invention will be further explained by means of the following examples.

### Experimental Approach 1

### Szilard Chalmers Reaction:

### EXAMPLE 1

### Irradiation of the Molybdenum Complexes

20-1500 mg of Mo(O)hexacarbonyl and Mo(VI)dioxodioxinate were sealed in a polyethylene capsule, and irradiated via the pneumatic facility in the Roger Onderwijs Reactor of Delft University of Technology, having a neutron fluence rate of 5.0×10¹² cm⁻²·s⁻¹ for a suitable length of time (15 minutes to 5 hours). Some of the irradiations were also carried out in the in-core radiation facility, which has a considerable higher fluence rate (2.4×10¹³ cm⁻²·s⁻¹), but a different neutron fluence rate profile (ratio of thermal to fast neutron fluence rates) compared to pneumatic facility. In the case of short irradiations (15-30 minutes), the radiochemical separation of ⁹⁹Mo was carried out 1 h after the end of irradiation, while in the case of longer irradiations, the separation was carried out 2 hours after the end of irradiation so as to allow the decay of shorter ¹⁰¹Mo and ¹⁰¹Tc with shorter half lives.

### EXAMPLE 2

### Liquid-Liquid Extraction of Organomolybdenum Targets

After irradiation the target was dissolved in 50 ml of purified organic liquid (dichloromethane (CH₂Cl₂), chloroform (CH₃Cl), benzene (C₆H₆), toluene (CH₃—C₆H₅)). 2.0 ml aliquots from the stock solution were contacted with equal volumes of aqueous phase of different pH (2-12), prepared in 50 mM ammonium acetate buffer. The pH of the buffer solutions was maintained by adding dilute acetic acid or ammonia solutions. Further, the following aqueous solutions were used: acidic solution HCl (0.05 M), alkaline solution NaOH (0.05 M), chelating solutions Na₂EDTA (0.05 M), Na₃citrate (0.05 M), oxidizing solution H₂O₂ (0.02 M) in HCl (0.05 M), reducing solution (NaHSO₃ (0.05 M), saline solution NaCl (0.9% w/w), neutral buffer solution NH₄Ac (0.05 M; pH 7.3). Experiments were also carried out with MilliQ water as aqueous phase. Kinetic studies on the solvent extraction of molybdenum from the organic solution into ammonium acetate. Experiments were also carried out with MilliQ water as aqueous phase. Kinetic studies on the solvent extraction of ⁹⁹Mo from dichloromethane into ammonium acetate buffer solution were carried out to optimize the time of equilibration for subsequent studies. In this experiment the samples were removed from the roller-bed at different time intervals ranging from 5 minutes to one hour. It was observed that the extraction yield of ⁹⁹Mo reached a constant value after 15 minutes, while that of total molybdenum increased up to 30 minutes of shaking time. Thus the highest enrichment factor was obtained for a shaking time of 15 minutes. In view of this the subsequent extractions were carried out with a shaking time of 15 minutes (Tomar et. al., 2008). After shaking the solutions for 15 minutes, the samples were centrifuged at 3000 rpm (Jouan) for 5 minutes to obtain clear separation of phasps, Subsequently 1.0 mL aliquots from the aqueous layer were taken for measurement of the ⁹⁹Mo radioactivity by gamma counting as well as determination of total molybdenum concentration. In the case of the dichloromethane stock solution, 0.2 mL aliquots (n=3) were first treated with aqua regia (3×1.0 mL concentrated HCl, plus 1×1.0 mL concentrated HNO₃) which after gamma counting were diluted up to 10 mL for determination of total Mo content (ICP-OES).

### EXAMPLE 3

### Analysis

The ⁹⁹Mo radioactivities of the organic phase, the aqueous phases and the dichloromethane-Mo stock solution were measured as follows:

The gamma-ray spectrometric measurement was carried out using a shielded well type NaI(Tl) counter coupled to a 2048 multichannel pulse height analyzer (Wallac). The peak at 140 keV due to ^{99m}Tc was used as an indication for the radio-activity of ⁹⁹Mo. Counting of the samples was carried out 24 hours after the radiochemical separation so as to obtain equilibrium between ^{99m}Tc and ⁹⁹Mo. The net peak area of 140 keV was obtained by linear subtraction of Compton background. The counting time was adjusted so as to obtain at least 10000 counts under the 140 keV peak. The total molybdenum concentration in the aqueous samples as well as the aqua regia destructed dichloromethane stock solutions were measured using Inductively Coupled Plasma Optical Emission Spectrometer (Perkin Elmer ICP-OES 4300DV). The emission lines at 202.031 nm, 203.845 nm and 204.597 nm were used for the measurement of molybdenum concentration. The instrument was calibrated for Molybdenum using a ICP-OES standard solution (Merck, Ultrapure 1.000 g Mo·L⁻¹), which was suitably diluted to obtain standard solutions in the range of 0.05 to 2.5 μg·mL⁻¹ Mo.

The specific radioactivity of ⁹⁹Mo (expressed in cpm/mg total Mo) in the aqueous phase and the stock solution was obtained from the ratio of the gamma activity and total Mo concentration. The enrichment factor was calculated as the ratio of specific activity of ⁹⁹Mo in the separated aqueous phase to that in the organic phase.

### Experimental Approach 2

### EXAMPLE 4

This experimental approach is based on the same chemical principles as the first approach. However, the liquid-liquid extraction is now performed simultaneously with the neutron bombardment. After completion of the irradiation/liquid-liquid extraction, the entire solution is processed in the same way as described in the above.

In this approach, benzene or toluene are the preferred phases for dissolution of the Mo compound since irradiation of dichloromethane or chloroform results in production of a very high and unpractical ³⁸Cl radioactivity besides intense high energy prompt gamma-radiation during the irradiation.

The advantage of the neutron beam irradiation is that the compound is exposed to a considerable smaller associated gamma-ray dose than during the irradiation ‘in’ the reactor. The gamma-radiation (resulting from the fission processes in the reactor) has, to some extent, a reverse effect to the recoil process (described as ‘annealing’). Another advantage is that also compounds may be considered risky for reactor irradiation because of possible chemical decomposition and formation of gaseous compounds which is unwanted for safety considerations. Such effects are almost negligible during beam irradiation and impose risks of a considerable smaller extent.

A disadvantage of the neutron beam irradiation is the lower neutron intensity and therefore the lower ⁹⁹Mo yield.

Examples 1, 2 and 3 relate to option according to claim 2 and example 4 relates to option according to claim 6.

It should be noted that the invention is not limited to the above-mentioned disclosure, examples or the claims.

1. A process for the production of no-carrier added ⁹⁹Mo of high specific radioactivity, characterized in that an ⁹⁸Mo containing chemical compound is bombarded with neutrons causing recoil of ⁹⁹Mo and subsequently separating the resulting ⁹⁹Mo.

2. The process of claim 1, characterized in that said resulting ⁹⁹Mo, incorporated in said compound, is transferred a) into a liquid in which only the produced ⁹⁹Mo dissolves, or b) transferred into a first liquid, in which said compound has a high solubility which liquid is mixed with a second liquid wherein said compound does not dissolve and the “loose” ⁹⁹Mo nuclei are transferred into said second liquid phase and removed.

3. The process of claim 1, characterized in that said ⁹⁸Mo containing chemical compound is molybdenum(O) hexacarbonyl [(Mo(CO)₆] or molybdenum (VI) dioxodioxinate [C₄H₃(O)—NC₅H₃)]₂—MoO₂.

4. The process of claim 1, characterized in that said first liquid is dichloromethane.

5. The process of claim 1, characterized in that the second liquid is an aqueous phase of different pH (2-12) prepared in 50 mM ammonium acetate buffer.

6. The process of claim 1, characterized in that a non-dissolvable ⁹⁸Mo containing compound is transferred into an irradiation container 1) containing the liquid in which only the produced ⁹⁹Mo dissolves, or 2) containing both the liquid in which the compound does dissolve, as well as the liquid in which only the ⁹⁹Mo dissolves, the container is, under continuous shaking, irradiated with neutrons in an external neutron beam. resulting in transfer of the recoiled ⁹⁹Mo on-line from one to another liquid phase.

7. The process of claim 6, characterized in that the ⁹⁸Mo containing chemical compound is molybdenum(O) hexacarbonyl [(Mo(CO)6] or molybdenum (VI) dioxodioxinate [C4H3(O)—NC5H3)]2—MoO2.
